(19) United States
(12) Patent Application Publication
(10) Pub. No.: US 2003/0234262 A1
(43) Pub. Date: Dec. 25, 2003

(54) Agitating and anti-bridging device for waste toner in a xerographic printing apparatus

(75) Inventor: Steven C. Hart, Webster, NY (US)

Correspondence Address: Xerox Corporation, Patent Documentation Center, Xerox Square 20th Floor, 100 Clinton Ave. S., Rochester, NY, 14644, US

(73) Assignee: Xerox Corporation

(21) Appl. No.: 10/179,531

(22) Filed: Jun. 24, 2002

(51) Int. Cl. G01F 11/00

(52) U.S. Cl. 222/233

(57) ABSTRACT

In a cleaning station for removing residual toner from a photoreceptor in a xerographic printing apparatus, the residual toner accumulates in a hopper, and an auger at the bottom of the hopper removes the accumulated toner. A thin, flexible member forming an agitator extends nearly vertically from the top of the hopper to the auger. Fingers at the end of the agitator contact the flights of the auger. There are between one and three more fingers than there are flights of the auger: the discrepancy causes an undulation of the agitator when the auger rotates.

### TECHNICAL FIELD

The present invention relates to xerographic printing apparatus, and more specifically, to an agitating device used in removing waste toner from such an apparatus.

### BACKGROUND

The basic principles of electrostatographic printing with dry marking material (hereinafter generally referred to as xerography) are well known: an electrostatic latent image is created on a charge-retentive surface, such as a photoreceptor or other charge receptor, and the latent image is developed by exposing it to a supply of toner particles, which are attracted as needed to appropriately-charged areas of the latent image. The toner particles are then transferred in imagewise fashion from the photoreceptor to a print sheet, the print sheet being subsequently heated to permanently fuse the toner particles thereto to form a durable image.

Following the transfer of the image from the photoreceptor to the print sheet, residual toner particles remaining on the photoreceptor are removed by any number of known means, such as including a cleaning blade, brush, and/or vacuum. In a typical embodiment, the removed toner is then accumulated in a hopper, and then the accumulated waste toner is directed, typically by means of an auger, into a waste container.

One practical problem with various devices for accumulating and otherwise handling waste toner is that the waste toner does not exhibit the desirable physical characteristics, such as flowability, of the new toner which is found in the developer supply. In contrast, the waste toner has, because of the xerographic process, experienced an alteration in its ratio of solid particles to other additives, as well as changes in its basic electrostatic characteristics. Consequently, the waste toner tends to behave in undesirable ways, such as by “clumping” or “bridging,” particularly if the waste toner is attempted to be moved through any enclosed space. Where an auger is involved, such as to direct waste toner to a collection bottle, the waste toner has been known to accumulate over the auger, so that eventually the auger merely forms a tunnel within a mass of compacted waste toner (i.e., the waste toner forms a “bridge”), and has no surface of the toner to grab; in such a case, the auger can remove no more toner, and toner will simply accumulate in the cleaning device.

### DESCRIPTION OF THE PRIOR ART

U.S. Pat. No. 5,575,408 discloses a toner agitator, for use in a development station of a xerographic printer, in which a mixing auger is in the form of a coil. A specially-shaped rod disposed within the coil contacts and deforms parts of the coil, to break up clumps and bridges in the marking material which may stick to the coil.

The xerographic printer marketed as the “D640” from Hewlett-Packard® uses a set of flexible fingers in combination with an auger which removes waste toner from a cleaning station. A representation of the position of the flexible fingers relative to the auger in shown herein as FIG. 5, and will be described in detail below.

### SUMMARY OF THE INVENTION

According to one embodiment of the invention, there is provided a xerographic printing apparatus, comprising means defining a hopper for accumulating marking material. An auger is rotatably mounted within the hopper, the auger having an effective length and defining along the effective length thereof a plurality of flights. An agitator is disposed within the hopper. The agitator comprises a thin, flexible member, and is mounted substantially at a top of the hopper and extending to the auger.

### BRIEF DESCRIPTION OF THE DRAWINGS

FIG. 1 is a simplified elevational view showing relevant elements of an electrostatographic printing apparatus.

FIG. 2 is a detailed elevational view of a cleaning station of an electrostatographic printing apparatus.

FIG. 3 is an elevational view, orthogonal to the view in FIG. 2, showing the interaction of a portion of the agitator with the flights of an auger.

FIG. 4 is a sectional view, through line 4-4 in FIG. 2 or 3, in effect through the agitator.

FIG. 5 is an elevational view, similar to that of FIG. 2, showing a known prior-art arrangement of flexible teeth with an auger in a cleaning station of a xerographic printer.

### DETAILED DESCRIPTION

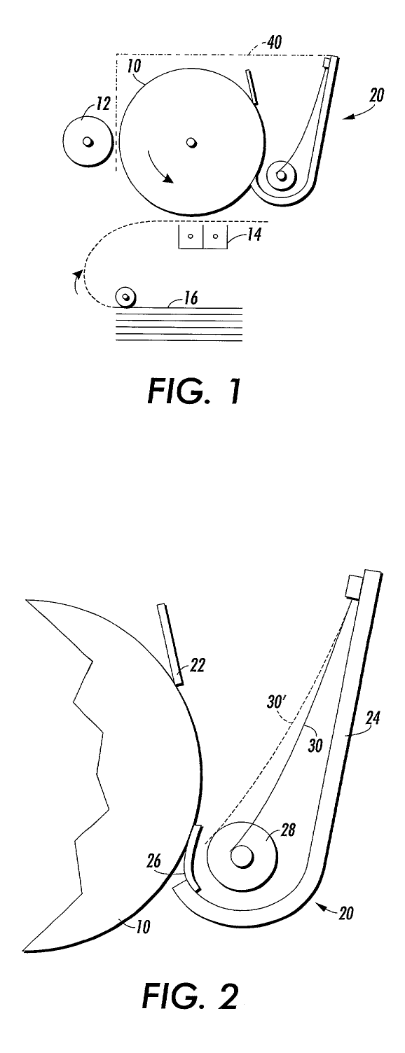

FIG. 1 is a simplified elevational view showing relevant elements of an electrostatographic or xerographic printing apparatus. As is well known, an electrostatic latent image is created, by means not shown, on a surface of a charge receptor or photoreceptor 10. The latent image is developed by applying thereto a supply of toner particles, such as with developer roll 12, which may be of any of various designs such as a magnetic brush roll or donor roll, as is familiar in the art. The toner particles adhere to the appropriately-charged areas of the latent image. The surface of photoreceptor 10 then moves, as shown by the arrow, to a transfer zone generally indicated as 14. Simultaneously, a print sheet on which an desired image is to be printed is drawn from supply stack 16 and conveyed to the transfer zone 14 as well.

At the transfer zone 14, the print sheet is brought into contact or at least proximity with a surface of photoreceptor 10, which at this point is carrying toner particles thereon. A corotron or other charge source at transfer zone 14 causes the toner on photoreceptor 10 to be electrically transferred to the print sheet. The print sheet is then sent to subsequent stations, as is familiar in the art, such as a fuser and finishing devices (not shown).

Following transfer of most of the toner particles to the print sheet in the transfer zone, any residual toner particles remaining on the surface of photoreceptor 10 are removed at a cleaning station, which is generally indicated as 20. FIG. 2 is an elevational view of a cleaning station 20, showing an embodiment of the present invention. As can be seen in the Figure, a cleaning blade 22 which is urged against the surface of photoreceptor 10 scrapes the residual toner off the surface. The toner which is thus removed falls downward into the housing 24 forming a hopper for accumulating the toner. A flexible flap seal 26, extending the length of the photoreceptor 10, prevents loose toner from escaping the hopper.

At the bottom of the hopper is an auger 28, here shown end-on. The auger extends substantially the length of the photoreceptor 10. The auger 28 is rotated and thus conveys toner particles at the bottom of the hopper to some sort of waste container (not shown).

As mentioned above, waste toner which is removed by the cleaning blade 22 has, because of the xerographic process, experienced an alteration in its ratio of solid particles to other additives, as well as changes in its basic electrostatic characteristics. Consequently, the waste toner tends to behave in undesirable ways, such as by “clumping” or “bridging,” particularly if the waste toner is attempted to be moved through any enclosed space, such as the hopper formed by photoreceptor 10 and housing 24. Where an auger such as 28 is involved, the waste toner has been known to accumulate over the auger, so that eventually the auger merely forms a tunnel within a mass of compacted waste toner (i.e., the waste toner forms a “bridge” over the auger 28), and has no surface of the toner to grab; in such a case, the auger can remove no more toner, and toner will simply accumulate in the cleaning station.

To address the problem, there is provided within the hopper what is here called an agitator, indicated as 30. The agitator 30 largely comprises a thin, flexible member which is rigidly mounted at a top edge thereof to a surface toward the top of the hopper. The agitator 30 extends downward to interact with the flights of the auger 28. As shown in FIG. 2, in this embodiment, the agitator 30 contacts the flights of auger 28, and depending on what specific portion of agitator 30 contacts what surface of the auger 28, different portions of the agitator 30 can be disposed at any time at the position marked 30′ or somewhere in between 30 and 30′, as will be described in detail below.

Certain attributes of agitator 30 are significant for avoiding clumping or bridging of waste toner in the hopper. First, the agitator extends from what is in effect the “top” of the hopper, meaning is occupies the volume in which waste toner could accumulate to form a bridge over the auger 28. Secondly, the agitator is substantially vertical in orientation: it should be mounted with its planar axis no more than 45 degrees, and preferably less than 25 degrees from vertical. This orientation ensures that the agitator itself does not cause any retention of waste toner in the hopper.

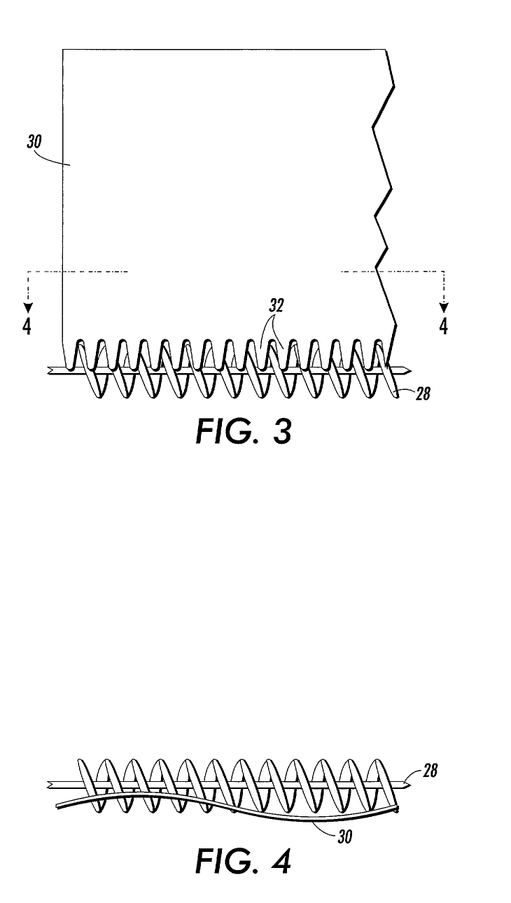

FIG. 3 is an elevational view, orthogonal to the view in FIG. 2, showing the interaction of a portion of the agitator 30 with the flights of auger 28. The thin, flexible member forming the bulk of agitator 30 defines, at the lower edge thereof, a plurality of fingers 32. The fingers are roughly comparable in size to the spacing of the flights forming auger 28; however, the fingers 32 are not perfectly aligned with the flights of auger 28. Rather, there are provided along the effective length of auger 28 (that is, the length of auger 28 disposed in the hopper, or corresponding to the length of photoreceptor 10) at least one, but no more than three, more teeth 32 than there are flights on auger 28. This discrepancy in spacing is shown in FIG. 3.

Comparing FIG. 2 and FIG. 3, it can be seen that, in locations where a finger 32 is disposed, at a given moment, between two flights of auger 28, the natural resiliency of agitator 30 causes the finger to be located near the core of auger 28, such as show as 30 in FIG. 2. At locations where a finger 32 is disposed near, on, or otherwise in contact with, a flight of auger 28, the finger will be pressed by the auger flight to a position closer to that shown as 30′ in FIG. 2.

FIG. 4 is a sectional view, through line 4-4 in FIG. 2 or 3, in effect through the agitator 30. It can be seen that, due to the discrepancy in spacing between the fingers 32 and the flights of auger 28, the thin, flexible member of agitator 30 is bent. More significantly, when the printing apparatus is operative, and the auger 28 is operating to auger out waste toner from the bottom of the hopper, the changing relationship between the moving flights and stationary fingers 32 will result in a sinusoidal undulation of the agitator 30, so that the various fingers 32 thereon will move in and out between positions 30 and 30′ in FIG. 2. This undulation both cleans the zones between flights of auger 28 and maintains motion of waste toner particles within the hopper above the auger 28. The frequency of the undulation relates to the “beat frequency” caused by the discrepancy between the spacing of the fingers 32 and the flights of auger 28: once again, in one practical embodiment, along the effective length of auger 28 there should be at least one, but no more than three, more teeth 32 than there are flights on auger 28. (The apparatus could also provide the same desirable undulation with one to three fewer teeth 32 than flights on auger 28.)

For a practical embodiment, the thin, flexible member forming all or most of agitator 30 comprises Mylar® or acetate, and is between 0.15 and 0.4 mm thick, most preferably 0.25 mm thick. The point-to-point spacing of the teeth 32 is about 7.5 mm. The agitator should have a length of between 2 cm to 5 cm between the teeth 32 and its top edge where it is mounted to a surface within the hopper. The housing 24 forming the bulk of the hopper can be made a permanent part of an entire printer, or can be part of a module which is readily removable from a larger printing apparatus, such a module further possibly including the photoreceptor 10 and any other elements useful in the xerographic process, as shown by the phantom lines indicated as 40 in FIG. 1.

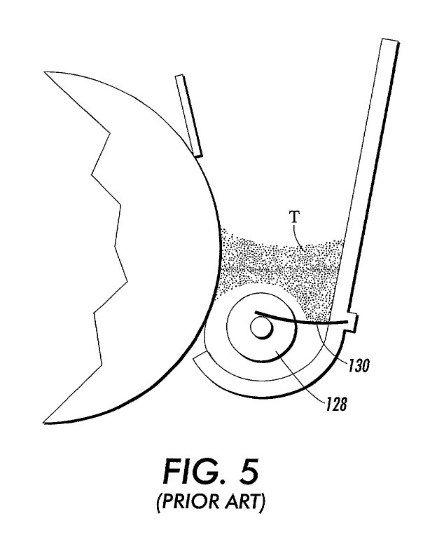

FIG. 5 is an elevational view, similar to that of FIG. 2, showing a known prior-art arrangement of flexible teeth with an auger in a cleaning station of xerographic printer, specifically the Hewlett-Packard® D640 printer referenced above. In this case, a set of flexible teeth 130 interact with an auger 128, but, in contrast with the present invention, the teeth are oriented closer to horizontal than vertical, and the teeth are not mounted on a larger agitator member which is disposed over the auger. Thus, the prior-art teeth would not be able to prevent a bridging of waste toner over the auger, such as shown as T in FIG. 5. Also, in the prior art, the teeth outnumber the total number of flights along the effective length of the auger by about ten.

In summary, the disclosed embodiment describes a cleaning station for a xerographic printer in which the practical problems of clumping and bridging of waste toner are overcome. The auger flights are constantly cleaned by the motion of the fingers, and major accumulations of waste toner are prevented by the undulation of the thin, flexible member through the bulk of the volume of the hopper. These results are achieved without the need for additional driven mechanical devices within the cleaning station.

Although the present invention finds immediate practical use in a cleaning station, it may also be useful in other contexts within xerographic printing, such as in a developing station.

1. A xerographic printing apparatus, comprising:
means defining a hopper for accumulating marking material;
an auger rotatably mounted within the hopper, the auger having an effective length and defining along the effective length thereof a plurality of flights; and
an agitator disposed with the hopper, the agitator comprising a thin, flexible member, the agitator being mounted substantially at a top of the hopper and extending to the auger.

2. The apparatus of claim 1, the agitator defining a plurality of fingers for interacting with the flights of the auger.

3. The apparatus of claim 2, the agitator defining a number of fingers which is at least one but no more than three different from a number of flights of the auger along the effective length of the auger.

4. The apparatus of claim 1, the thin, flexible member being rigidly mounted at a top edge thereof to the top of the hopper.

5. The apparatus of claim 1, the thin, flexible member extending a length between the top edge thereof and the auger of at least 2 cm.

6. The apparatus of claim 1, the thin, flexible member being oriented within 45 degrees of vertical.

7. The apparatus of claim 6, the thin, flexible member being oriented within 25 degrees of vertical.

8. The apparatus of claim 1, wherein the hopper is configured to accumulate residual marking material.

9. The apparatus of claim 9, further comprising means for removing residual marking material from a surface of a charge receptor, wherein the removed marking material enters the hopper.

10. The apparatus of claim 1, the apparatus in a form of a module which is readily removable from a larger printing apparatus.

11. The apparatus of claim 10, the module including a charge receptor.
